(19) United States
(12) Patent Application Publication
(10) Pub. No.: US 2008/0211863 A1
(43) Pub. Date: Sep. 4, 2008

(54) INKJET RECORDING APPARATUS

(75) Inventor: Tadanobu Chikamoto, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHUIKI KAISH, Nagoya-shi (JP)

(21) Appl. No.: 12/041,089

(22) Filed: Mar. 3, 2008

(30) Foreign Application Priority Data
Mar. 1, 2007 (JP) 2007051064

(51) Int. Cl. B41J 2/165

(52) U.S. Cl. 347/33

(57) ABSTRACT

The invention is directed to an inkjet recording apparatus having an inkjet head, a cap, and a moving mechanism. The inkjet head has an ejection surface having ink ejection openings. The cap is made of first and second extending portions, each of which has a leading edge closest to the ejection surface. The first and second portions define at least one enclosure. The particular moving mechanism moves one or both of the cap and the inkjet head between a first position and a second position. Each of the first extended portions extends further toward the ejection surface than each of the second extended portions. When the inkjet head and the cap are in the first position, the first extended portions contact the ejection surface, and the leading edges of the second extended portions are a predetermined distance away from the ejection surface.

### CROSS REFERENCE TO RELATED APPLICATION

The present application claims priority from Japanese Patent Application No. 2007-051064, which was filed on Mar. 1, 2007, the disclosure of which is herein incorporated by reference in its entirety.

### BACKGROUND OF THE INVENTION

1. Field of the Invention

The present invention relates to an inkjet recording apparatus that comprises an inkjet head configured to eject ink.

2. Description of Related Art

A known inkjet recording apparatus, has a maintenance unit including a blade, a wipe roller, an ink receiving member, and a purge cap. The maintenance unit covers a nozzle surface with the purge cap. Then, a suctioning purge is performed by applying suctioning force to nozzles to remove dust, ink containing air bubbles, and/or viscous ink from nozzles. Ink adhering to the nozzle surface is removed by the ink receiving member, the wipe roller and the blade. In a known ink jet apparatus, if foreign matters adhere to the purge cap, they may transfer to or adhere to the nozzle surface when the maintenance operation is performed. As a result, characteristics of ink ejection from the nozzles may be inconsistent.

### SUMMARY OF THE INVENTION

Therefore, a need has arisen for inkjet recording apparatus which overcome these and other shortcomings of the related art. A technical advantage of the present invention is to provide an inkjet recording apparatus that will reduce amounts of foreign matters adhering to an ink ejection surface.

In an embodiment of the invention, an inkjet recording apparatus comprises an inkjet head comprising an ejection surface having a plurality of ink ejection openings formed therethrough, a cap comprising a plurality of first extended portions and a plurality of second extended portions, wherein each of the plurality of first and second extended portions comprises a leading edge closest to the ejection surface, and the plurality of first and second extended portions combine to define at least one enclosure configured to open toward the ejection surface, and a particular moving mechanism configured to move at least one of the cap and the inkjet head between a first position and a second position, wherein at least a portion of each of the first extended portions extends further toward the ejection surface than each of the plurality of second extended portions, and wherein when the inkjet head and the cap are in a first position, at least a portion of each of the plurality of first extended portions contacts the ejection surface, and at least a portion of the leading edges of each of the plurality of second extended portions is a predetermined nonzero distance from the ejection surface.

In another embodiment of the invention, an inkjet recording apparatus comprises an inkjet head comprising an ejection surface having a plurality of ink ejection openings formed therethrough, and at least one projection recess formed therein, a cap comprising a plurality of first extended portions and a plurality of second extended portions, wherein each of the plurality of first and second extended portions comprises a leading edge closest to the ejection surface, and the plurality of first and second extended portions combine to define at least one enclosure configured to open toward the ejection surface, and a particular moving mechanism configured to move at least one of the cap and the inkjet head between a first position and a second position, wherein the plurality of first extended portions extend a predetermined distance toward the ejection surface, and at least one of the plurality of second extended portions comprises at least one projection that extends closer to the ejection surface than the plurality of first extended portions and wherein when the cap and the inkjet head are in the first position, the first extended portions contact the ejection surface, and the at least one projection enters a corresponding at least one projection recess in the ejection surface.

Other objects, features, and advantages will be apparent to persons of ordinary skill in the art from the following detailed description of the invention and the accompanying drawings.

### BRIEF DESCRIPTION OF THE DRAWINGS

For a more complete understanding of the present invention, needs satisfied thereby, and the objects, features, and advantages thereof, reference now is made to the following description taken in connection with the accompanying drawings.

FIG. 1 is a side cross-sectional view of an inkjet printer as an inkjet recording apparatus according to an embodiment of the present invention.

FIG. 2 is a plan view of a specific portion of the inkjet printer of FIG. 1.

FIG. 3 is a cross-sectional view of the inkjet printer, taking along the line III-III of FIG. 2.

FIG. 4 is a perspective view of a cap of a maintenance unit of the ink jet printer according to an embodiment of the invention.

FIG. 5A is a schematic showing an inkjet head moving from a print position to a head maintenance position and a tray of the maintenance unit moving to the maintenance position, according to an embodiment of the invention.

FIG. 5B is a schematic showing an ink receiving member and a wiper wiping off ink adhering to an ink ejection surface, according to an embodiment of the invention.

FIG. 6A is a schematic showing the maintenance unit moving to the maintenance position according to an embodiment of the invention.

FIG. 6B is a partially enlarged view showing the cap and the ink ejection surface in contact with each other according to an embodiment of the invention.

FIG. 7A is a plan bottom view of a head body of an inkjet printer according to another embodiment of the invention.

FIG. 7B is a cross-sectional view of the head body, taking along the line VII-VII of FIG. 7A.

FIG. 8 is a perspective view of a cap of a maintenance unit of the ink jet printer according to another embodiment of the invention.

FIGS. 9A and 9B are schematics showing movements of the cap to contact the ink ejection surface, according to another embodiment of the invention.

### DETAILED DESCRIPTION OF EMBODIMENTS OF THE INVENTION

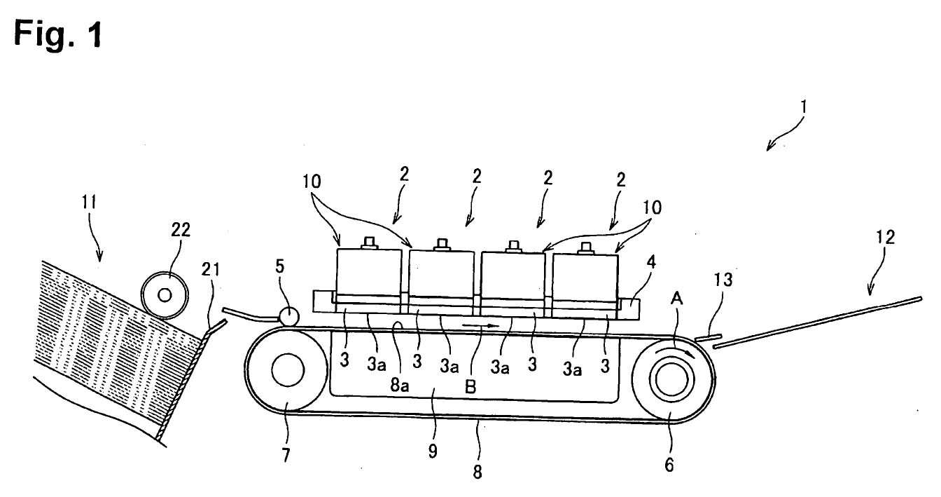

Embodiments of the present invention, and their features and advantages, are understood by referring to FIGS. 1-9B, with like numerals being used for like corresponding parts in the various drawings.

As shown in FIG. 1, in an embodiment of the invention, a color inkjet printer 1, as an inkjet recording apparatus, may comprise a plurality of, e.g., four, inkjet heads 2. Inkjet printer 1 further may comprise a sheet feeder 11 and a sheet discharger 12, which may be disposed on the left and right sides in FIG. 1, respectively.

Inkjet printer 1 may have a sheet feeding path therein through which a sheet, as a recording medium, is fed from sheet feeder 11 toward sheet discharger 12. Sheet feeder 11 may comprise a pick-up roller 22 configured to send out an uppermost one of sheets accommodated in a sheet tray 21 in a sheet feeding direction B, e.g., from left to right as shown in FIG. 1.

Belt rollers 6, 7 and an endless conveyor belt 8 looped around rollers 6, 7 may be disposed in a middle of the sheet feeding path. Conveyor belt 8 may have a sheet conveying surface 8a on its outer surface, which may be treated with silicone to provide adhesion thereto. A pressing roller 5 may be disposed immediately downstream of sheet feeder 11 in the sheet feeding direction B to face conveyor belt 8. Pressing roller 5 may press a sheet fed by sheet feeder 11 against sheet conveying surface 8a of conveyor belt 8. While conveyor belt 8 holds a sheet, pressing roller 5 may press the held sheet against sheet conveying surface 8a. With its adhesion, conveyor belt 8 may feed the sheet in the sheet feeding direction B. A motor (not shown) may drive belt roller 6, which may be disposed on the downstream side in the sheet feeding direction B. The motor (not shown) may cause belt roller 6 to rotate in the clockwise direction in FIG. 1, as shown by the arrow A.

A separation member 13 may be positioned substantially immediately downstream of the conveyor belt 8 in the sheet feeding direction B, along the sheet feeding path. Separation member 13 may separate a sheet adhesively held on sheet conveying surface 8a therefrom, and feed the sheet toward sheet discharger 12.

A platen 9 may have a substantially rectangular parallelepiped shape, and may be disposed in an area surrounded by conveyor belt 8 such that platen 9 faces inkjet heads 2. Platen 9 may support conveyor belt 8 from the inside of conveyor belt 8 by contacting an inner surface of an upper portion of conveyor belt 8.

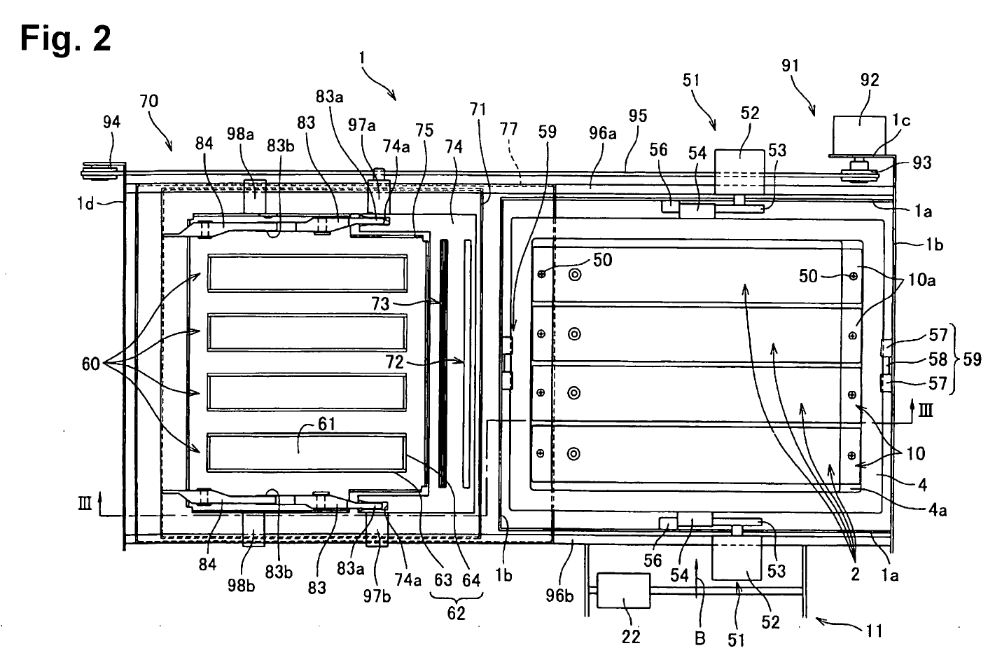

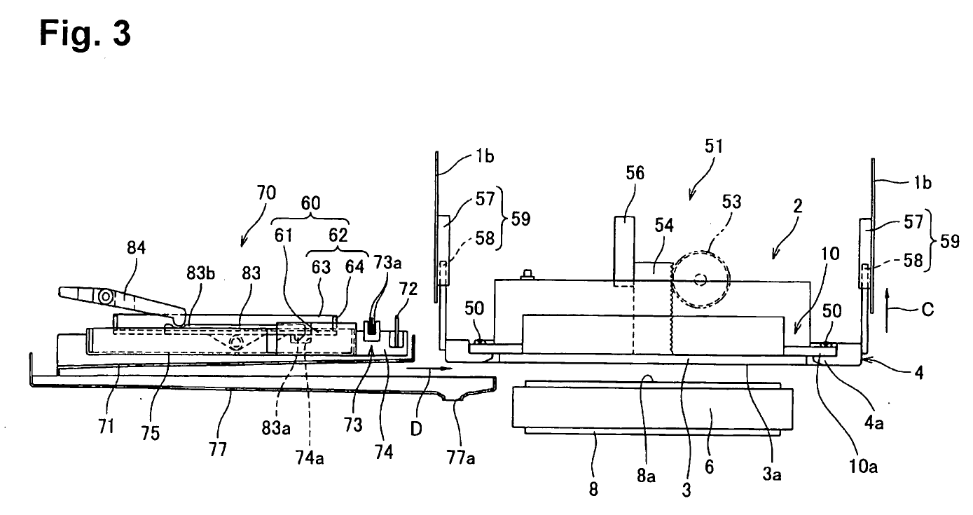

Inkjet printer 1 may be a line printer comprising a plurality of e.g., four, inkjet heads 2 that may be disposed along the sheet feeding direction B. Inkjet heads 2 may correspond to four ink colors, e.g., magenta (M), yellow (Y), cyan (C), and black (K). As shown in FIG. 2, each inkjet head 2 may have a substantially rectangular parallelepiped shape, elongated in a direction perpendicular to the sheet feeding direction B (from bottom to top in FIG. 2). As shown in FIGS. 1 and 3, a head body 3 may be provided at the lower end of each inkjet head 2. Head body 3 may have a flow path unit and an actuator unit laminated. An ink flow path, including pressure chambers, may be formed in the flow path unit. An actuator unit may apply pressure to ink in the pressure chambers.

Reservoir unit 10 may be positioned on an upper surface of head body 3 to supply ink to head body 3. As shown in FIGS. 2 and 3, each reservoir unit 10 may have a head fixing portion 10a that is longer than the length of head body 3, in a direction perpendicular to the sheet feeding direction B. Head fixing portion 10a may be positioned on each end of head body 3 in its longitudinal direction. Head fixing portions 10a also may be positioned to a support portion 4a of a frame 4, as described herein.

A plurality of e.g., four inkjet heads 2 may be adjacently arranged in the sheet feeding direction B, while being fixed to frame 4. As shown in FIGS. 2 and 3, frame 4 may have support portion 4a that extends to a position to face lower surfaces of head fixing portions 10a of reservoir units 10. Support portion 4a and head fixing portions 10a may be fixed using any suitable fixer, e.g., screws 50. Thus, inkjet heads 2 may be fixed to frame 4, while being surrounded by frame 4. As shown in FIG. 3, bottom surfaces, e.g., ink ejection surfaces 3a, of inkjet heads 2 may be substantially flush with support portion 4a and may be exposed from an opening of frame 4.

Frame 4 may be movably supported by frame moving mechanism 51 of inkjet printer 1. Frame moving mechanisms 51 may be positioned outside inkjet heads 2 in their arrangement direction, e.g., at top and bottom portions in FIG. 2. Each frame moving mechanism 51 may comprise a drive motor 52, as a drive source, configured to vertically move frame 4, a pinion gear 53 attached to a shaft of drive motor 52, a guide 56, a rack gear 54 positioned upwardly from frame 4 and between guide 56 and pinion gear 53, such that rack gear 54 engages pinion gear 53.

Each drive motor 52 may be attached to one of body frames 1a of inkjet printer 1, which may be disposed opposite to each other in the sheet feeding direction B. Each rack gear 54 may extend substantially vertically, with its lower end portion attached to a side surface of frame 4. A surface of rack gear 54 opposite to pinion gear 53 may slidably contact guide 56. Guides 56 may be attached to body frames 1a.

Drive motors 52 may be synchronously driven to rotate each pinion gear 53 in forward or reverse directions. When pinion gears 53 are rotated in the forward or reverse directions, rack gears 54 may move upward or downward. With the movement of rack gears 54, frame 4 and inkjet heads 2 may move upward or downward.

A guide unit 59 may be positioned on each end of inkjet heads 2 in their longitudinal direction. Each guide unit 59 may comprise a bar member 58 and a pair of guides 57 which slidably interpose bar member 58 between guides 57. As shown in FIG. 3, each guide 57 and each bar member 58 may extend vertically. Each pair of guides 57 may be fixed to one of body frames 1b that are positioned opposite to each other in a direction perpendicular to the sheet feeding direction B. Bar member 58 may be attached to a side surface of frame 4, parallel to and opposite to body frame 1b. When frame 4 is moved up or down by frame moving mechanisms 51, guide units 59 may reduce an inclination of ink ejection surfaces 3a of inkjet heads 2 with respect to sheet conveying surface 8a of conveyor belt 8. In other words, even when frame 4 and inkjet heads 2 are moved vertically by frame moving mechanisms 51, ink ejection surfaces 3a and sheet conveying surface 8a may remain substantially parallel to each other. This structure may improve accuracy of ink impingement to a sheet during printing.

As shown in FIG. 3, frame 4 generally may be placed in a print position, in which inkjet heads 2 may perform printing by ejecting ink onto a sheet. When a maintenance operation is performed for inkjet heads 2, frame moving mechanisms 51 may move frame 4 in a direction C, as indicated in FIG. 3, to a head maintenance position, which may be above the print position. Maintenance operations may include purging to forcibly eject ink from inkjet heads 2, wiping ink adhered to ink ejection surfaces 3a, and covering ink ejection surfaces 3a with caps 60.

When printing is performed, frame moving mechanisms 51 may move frame 4 downward, to provide a small gap between sheet conveying surface 8a of conveyor belt 8 and bottom surfaces of head bodies 3, e.g., ink ejection surfaces 3a. The gap may function as a part of the sheet feeding path. When a sheet conveyed by conveyor belt 8 sequentially passes immediately below four head bodies 3, inkjet heads 2 may eject ink droplets of each color onto an upper surface of the sheet, to form a desired color image on the sheet.

As shown in FIGS. 2 and 3, maintenance unit 70 may be positioned on the left side of inkjet heads 2. As shown in FIG. 3, maintenance unit 70 may comprise trays 71, 75 configured to move substantially horizontally. As shown in FIGS. 2 and 3, tray 71 may have square box shape with an open end facing upward. Tray 71 may surround tray 75. Tray 71 may be attached to or separate from tray 75. Tray 71 may be attached to tray 75 with recess portions 74a and hooks 83a configured to be engaged. Trays 71, 75 maybe separated from each other according to maintenance operations.

As shown in FIG. 3, tray 71 may be open on a side opposing inkjet heads 2. For example, when purging is performed, trays 71, 75 may be disengaged, and tray 71, which may be configured to surround tray 75, may move, leaving tray 75 in place. When maintenance unit 70 moves horizontally, as described herein, frame 4 first may move up, in a direction C, to the head maintenance position, regardless of whether recess portions 74a and hooks 83a are engaged or disengaged. As frame 4 moves up, a space may be provided between ink ejection surfaces 3a and sheet conveying surface 8a for maintenance unit 70. Then, maintenance unit 70 may move horizontally in a direction D, as shown by an arrow in FIG. 3.

A waste ink tray 77 may be positioned substantially immediately below maintenance unit 70. Waste ink tray 77 may be sized such that waste ink tray 77 surrounds tray 71, when viewed in plan view. Referring again to FIG. 2, when tray 71 is moved to a right end, waste ink tray 77 may overlap with a rim of tray 71, opposite to inkjet heads 2. An ink outlet 77a may be positioned on waste ink tray 77 at an end closer to inkjet heads 2. Ink outlet 77a may pass through waste ink tray 77 in a vertical direction. Waste ink which flows onto waste ink tray 77 may flow to a waste ink reservoir (not shown) through ink outlet 77a.

Tray 71 may accommodate a wiper 72 therein, an ink receiving member 73 and tray 75, in this order, starting from side of tray 71 closer to inkjet heads 2. Wiper 72, ink receiving member 73 and trays 71, 75 may extend parallel to the sheet feeding direction B. As shown in FIG. 2, a plurality of, e.g., four, caps 60 may be positioned in tray 75, corresponding to inkjet heads 2. Each cap 60 may have a substantially rectangular shape when viewed in plan view. Caps 60 may be arranged in the sheet feeding direction B at the same pitch as inkjet heads 2, such that a longitudinal direction of each cap 60 may be parallel to a longitudinal direction of each inkjet head 2.

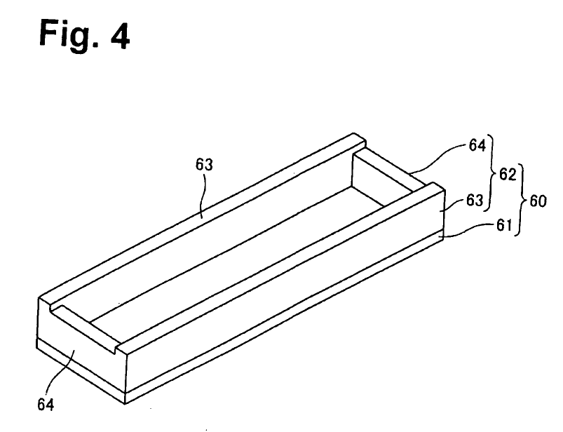

As shown in FIG. 4, each cap 60 may comprise a plate member 61, and an enclosure 62 extending upward from a periphery of plate member 61. Plate member 61 may have a rectangular shape when viewed in plan view. Enclosure 62 may be formed an elastic material, e.g., rubber. Enclosure 62 may comprise a pair of first extended portions 63 and a pair of second extended portions 64. Extended portions 63 may extend in a direction parallel to a longitudinal direction of cap 60, e.g., a movement direction of tray 75. Second extended portions 64 may extend in a width direction, e.g., perpendicular to the movement direction of tray 75, of cap 60. Each second extended portion 64 may be connected to ends of first extended portions 63. First extended portions 63 and second extended portions 64 may define a recess that opens toward ink ejection surface 3a.

First extended portions 63 may be positioned such that they contact longitudinal portions of a periphery of a nozzle area of ink ejection surface 3a. First extended portions 63 may have a constant height with respect to plate member 61 in the longitudinal direction of first extended portions 63. Second extended portions 64 may be positioned such that second extended portions 64 face portions of the periphery of the nozzle area of ink ejection surface 3a when first extended portions 63 contact ink ejection surface 3a. Second extended portions 64 may have a constant height with respect to plate member 61, and that constant height may be slightly lower than the constant height of first extended portions 63. Upper surfaces of second extended portions 64, may be disposed upstream and downstream of ink ejection surface 3a in a direction of wiping ink ejection surface 3a by wiper 72. Therefore, when an upper surface of each first extended portion 63 contacts ink ejection surface 3a, an upper surface of each second extended portion 64 may be positioned close to ink ejection surface 3a, with some distance between the upper surfaces of second extended portions 64 and ink ejection surface 3a.

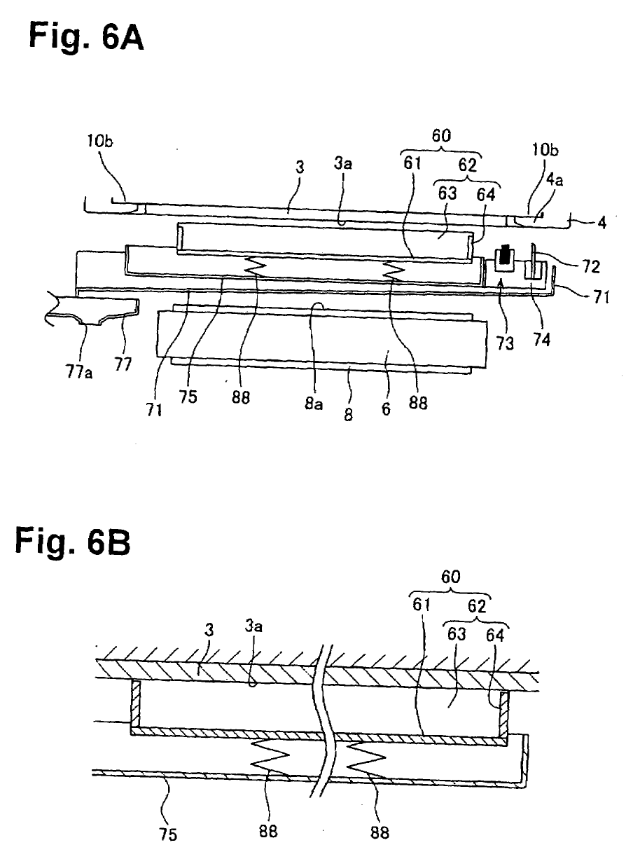

Therefore, a space defined by cap 60 and ink ejection surface 3a may be brought into an almost sealed state, which may prevent ink in the nozzles from drying. Referring now to FIGS. 6A and 6B, each cap 60 may be urged upward by a plurality of, e.g., two, springs 88 while being supported by a bottom surface of tray 75.

Wiper 72 and ink receiving member 73 may be positioned in a holding member 74. Referring back to FIG. 2, holding member 74 may be fixed on a side of tray 71 closer to inkjet heads 2. Holding member 74 may have a substantially angular “C” shape, when viewed as shown in FIG. 2 in plan view. Holding member 74 may hold wiper 72 and ink receiving member 73 along the sheet feeding direction B. Recess portions 74a may be positioned at each end of holding member 74, and may extend in a direction perpendicular to the sheet feeding direction B.

As shown in FIGS. 2 and 3, ink receiving member 73 may comprise a plurality of thin plates 73a. Each thin plate 73a may be slightly longer than the total width of inkjet heads 2. Thin plates 73a may formed of a metal, e.g., stainless steel, and may be positioned parallel to each other, with a distance to cause capillary force for receiving ink. Similarly to thin plates 73a, wiper 72 may be longer than the total width of inkjet heads 2. The longitudinal direction of wiper 72 may be parallel to the sheet feeding direction B. Wiper 72 may be formed of elastic material, e.g., rubber.

Trays 71, 75 may be engaged with or disengaged from each other via recess portions 74a and hook members 83. As shown in FIG. 2, recess portions 74a and hook members 83 may be disposed near side surfaces, e.g., upper and lower surfaces when viewed as shown in FIG. 2, of trays 71, 75. Each hook member 83 may extend in a direction perpendicular to the sheet feeding direction B, and also may be pivotally supported about its middle portion. Hook 83a may be positioned at an end of hook member 83 that is closer to inkjet heads 2. Referring to FIG. 3, when hook members 83 pivot clockwise, each hook 83a may engage with corresponding recess portion 74a. One or more contact members 84 may be pivotally positioned on a top of maintenance unit 70 in correspondence with hook members 83. When contact members 84 pivot clockwise, an end of each contact member 84 closer to inkjet heads 2 may contact an end 83b of corresponding hook member 83, opposite to the end closer to inkjet heads 2. As contact members 84 contact corresponding ends 83b, recess portions 74a and hooks 83a may disengage from each other. When contact members 84 disengage from corresponding ends 83b, recess portions 74a and hooks 83a may engage with each other.

Referring to FIG. 3, when a maintenance operation is not performed for inkjet heads 2, maintenance unit 70 may be in the retracted position, away from inkjet heads 2. More specifically, when maintenance unit 70 is in the retracted position, maintenance unit 70 may be positioned at a left-side position, with respect to FIG. 2. In this position, maintenance unit 70 does not face inkjet heads 2. When a maintenance operation is performed, maintenance unit 70 may move horizontally from the retracted position to a maintenance position in which maintenance unit 70 faces ink ejection surfaces 3a, e.g., a right-side position with respect to FIG. 2. Inkjet heads 2 then may move into the head maintenance position, in which tips of wiper 72 and caps 60 may not contact ink ejection surfaces 3a.

When performing a maintenance operation, e.g., purging, tray 71 may move from the retracted position to the maintenance position, to receive ink discharged from the nozzles, while tray 75 may be left in place. When caps 60 cover corresponding ink ejection surfaces 3a, recessed portions 74a and corresponding hooks 83a may engage, which may cause trays 71, 75 to connect to each other and move to a position in which caps 60 face corresponding ink ejection surfaces 3a. As shown in FIG. 2, trays 71, 75 may be movably supported by a plurality of, e.g., two, guide shafts 96a, 96b extending in a direction perpendicular to the sheet feeding direction B. Tray 71 may comprise a plurality of, e.g., two, bearing members 97a, 97b that may extend from top and bottom surfaces of holding member 74. Similarly, tray 75 may comprise a plurality of, e.g., two, bearing members 98a, 98b that may extend from top and bottom surfaces of holding member 74. Each end of guide shafts 96a, 96b may be fixed to one of body frames 1b, 1d. Guide shafts 96a, 96b may be positioned parallel to each other, between body frames 1b, 1d. Trays 71, 75 may move along guide shafts 96a, 96b, in the right and left direction, as shown in FIGS. 2 and 3.

As shown in FIG. 2, a driving mechanism 91 may be configured to move trays 71, 75 horizontally. Driving mechanism 91 may comprise a tray motor 92, a motor pulley 93, an idle pulley 94, a timing belt 95, and guide shafts 96a, 96b. Tray motor 92 may be fixed by any suitable fixer, e.g., a screw, to a mounting portion 1c positioned substantially at an end of body frame 1b extending parallel to the sheet feeding direction B. Tray motor 92 may be connected to motor pulley 93, and may rotate motor pulley 93. Body frame id may be positioned on the left side as shown in FIG. 2, and may rotatably support idle pulley 94. Timing belt 95 may be positioned parallel to guide shaft 96a. Timing belt 95 may be wound around motor pulley 93 and idle pulley 94. Timing belt 95 also may be connected to bearing member 97a, which may be positioned on holding member 74. Tray 71 may be connected to timing belt 95 via bearing member 97a,

When tray motor 92 drives motor pulley 93 in a forward or reverse direction, timing belt 95 may run. As timing belt 95 runs, tray 71 may move left or right as shown in FIG. 2, e.g., to the retracted position, e.g., the left-side, or the maintenance position, e.g., the right side. When recess portions 74a of holding member 74 engage with corresponding hooks 83a, wiper 72 and ink receiving member 73 positioned in tray 71, and caps 60 positioned in tray 75, may move together, e.g., to the maintenance position or to the retracted position. When recess portions 74a disengage from relevant hooks 83a, wiper 72 and ink receiving member 73, which may be positioned in tray 71, may move to the maintenance position or retracted position.

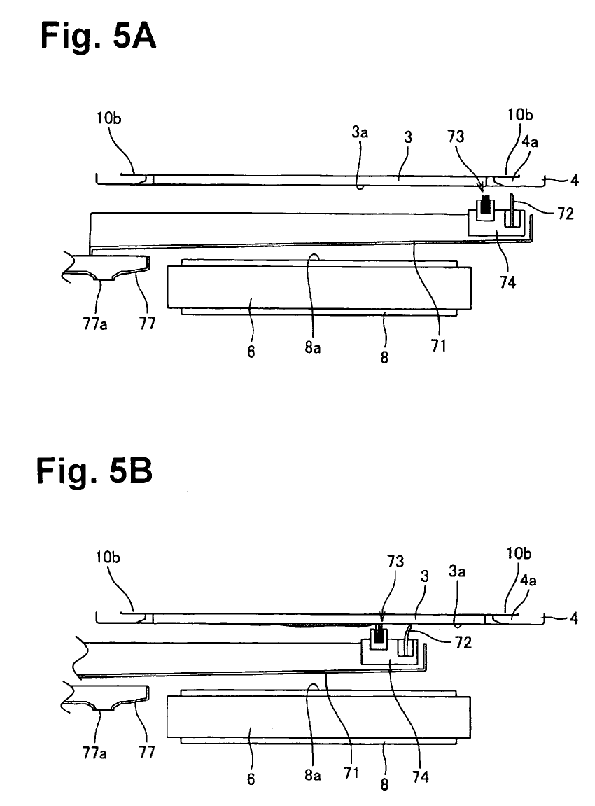

Referring to FIGS. 5A-6B, maintenance unit 70 may carry out operations. To recover inkjet heads 2 from ink ejection failures, purging operation may be performed. When maintenance unit 70 carries out a purging operation, frame moving mechanisms 51 may move frame 4 upward. At this time, two drive motors 52 may be synchronously driven to rotate each pinion gear 53 in the forward direction, e.g., the clockwise direction as shown in FIG. 3. The rotation of pinion gears 53 may cause rack gears 54 to move up. When rack gears 54 move, frame 4, which may be fixed to rack gears 54, also may move up, together with inkjet heads 2. When frame 4 and inkjet heads 2 reach the head maintenance position, drive motors 52 may stop rotating. Thus, a space may be provided between ink ejection surfaces 3a and conveying belt 8, for maintenance unit 70. When maintenance unit 70 moves to the maintenance position, ink ejection surfaces 3a of inkjet heads 2 may be placed in the head maintenance position, and contact between the bottom of frame 4 and the tips of wiper 72 or enclosures 62 may be avoided.

After maintenance unit 70 moves into the maintenance position, contact members 84 may contact corresponding ends 83a of hook members 83 to disengage recess portions 74a from corresponding hooks 83a. Thus, trays 71, 75 may be disconnected from each other. In this state, motor 92 of driving mechanism 91 may be driven, which may run timing belt 95. The running of timing belt 95 may cause tray 71 to move to the maintenance position. As shown in FIG. 5A, as tray 71 reaches the maintenance position, motor 92 may stop. Then, a pump (not shown) configured to forcibly flow ink stored in an ink tank to inkjet heads 2 may be driven to perform purging operation, e.g., an operation in which ink is ejected from nozzles of the inkjet heads 2 into tray 71. With purging operation, some conditions which may cause ink ejection failures may be resolved, e.g., ink clogging the nozzles may be cleared, or viscous ink present in the nozzles may be forced out. Ink, which may be discharged to tray 71, may move along its bottom surface to the left side in FIG. 5A, into waste ink tray 77. Ink discharged to waste ink tray 77 during purging may flow through ink outlet 77a. Some ink may remain on ink ejection surface 3a, as an ink droplet.

After completion of the purging operation, frame moving mechanisms 51 may lower inkjet heads 2. At this time, inkjet heads 2 may be positioned such that the tip of wiper 72 contacts ink ejection surfaces 3a and a lower surface of frame 4, when tray 71 is moved to the left in FIG. 5A, i.e., to the retracted position. Inkjet heads 2 also may be positioned such that a space of, e.g., 0.5 mm, between ink ejection surfaces 3a and upper edges of thin plates 73a of ink receiving member 73 is provided. As shown in FIG. 5B, driving mechanism 91 may move tray 71 in a wiping direction, e.g., a leftward direction as shown in FIGS. 5A and 5B, from the maintenance position to the retracted position, which may cause wiper 72 to wipe ink ejection surfaces 3a.

The tip of wiper 72 may be positioned above the lower surface of frame 4, such that wiper 72 may flexibly contact the lower surface of frame 4 and ink ejection surfaces 3a, to wipe off ink which may have adhered to ink ejection surfaces 3a during purging. Upper edges of thin plates 73a of ink receiving member 73 may be positioned close to ink ejection surfaces 3a at a small distance therefrom, without contacting ejection surfaces 3a. With such a structure, relatively large ink droplets adhered to ink ejection surfaces 3a may move between thin plates 71a with capillary action.

Thus, the maintenance operations of purging, to recover inkjet heads 2 from ink ejection failures, and wiping, to wipe ink adhered during purging to ink ejection surfaces 3a, may end. The lower surface of frame 4 may be positioned to be flush with the ink ejection surfaces 3a, such that wiper 72 also may wipe off the lower surface of frame 4 when the tray 71 moves to the retracted position.

Another maintenance operation, e.g., a capping operation, may be performed when printing is not performed for a predetermined time. A capping operation may cause caps 60 to cover corresponding nozzles formed on each ink ejection surface 3a. For the capping operation, frame moving mechanisms 51 may move inkjet heads 2 from the print position to the head maintenance position. With trays 71, 75 connected to each other via hook members 83, driving mechanism 91 may move trays 71, 75 to the maintenance position. Enclosure 62 of cap 60 may be positioned opposite to a periphery of an area of ink ejection surface 3a where nozzles are formed. More specifically, first extended portions 63 may be positioned opposite to longitudinal peripheral portions of the nozzle area of ink ejection surface 3a. Second extended portions 64 may be positioned opposite to breadthways peripheral portions of the nozzle area of ink ejection surface 3a.

As shown in FIG. 6B, frame moving mechanisms 51 may cause inkjet heads 2 to move lower until upper edges of first extended portions 63 contact with ink ejection surface 3a. Because second extended portions 64 may be slightly shorter than first extended portions 63, upper edges of second extended portions 64 may not contact ink ejection surface 3a. Instead, upper edges of second extended portions 64 maybe disposed close to ink ejection surface 3a. Nevertheless, a space defined by cap 60 and ink ejection surface 3a may be extremely close to a sealed state, which may prevent or slow the drying of ink in the nozzles.

When first extended portions 63 contact ink ejection surface 3a, second extended portions 64 that are positioned upstream and downstream, in the wiping direction with wiper 72, of the nozzles formed on ink ejection surface 3a, may be positioned away from ink ejection surface 3a. Therefore, foreign matters which may be adhered to extended portions 64 are unlikely to adhere to ink ejection surface 3a on the upstream and downstream sides of the nozzles in the wiping direction. Therefore, when ink ejection surfaces 3a are wiped off by wiper 72, a number of foreign matters which are pushed into the nozzles may be reduced or eliminated.

Further, a number of foreign matters on second extended portions 64 which are transferred or adhered to a portion of wiper 72 where it wipes nozzles, via ink ejection surface 3a, may be reduced or eliminated. As foreign matters may be unlikely to adhere to a portion of wiper 72 where wiper 72 wipes nozzles, a number of foreign matters which are pushed into the nozzles when ink ejection surface 3a is wiped again by wiper 72 may be reduced or eliminated.

In an embodiment of the invention, an entire portion of second extended portion 64 may be lower in height than first extended portion 63. Nevertheless, in another embodiment of the invention, a portion of second extended portion 64 may be lower in height than first extended portion 63, and another portion of second extended portion 64 may be greater in height than first extended portion 63. In this embodiment, when first extended portions 63 contact ink ejection surface 3a, a portion of upper edges of second extended portions 64 may contact ink ejection surface 3a, and another portion of second extended portions 64 may not contact ink ejection surface 3a. Accordingly, a number of foreign matters that may attach to ink ejection surface 3a upstream and downstream of the nozzles in the wiping direction, may be reduced. Therefore, when ink ejection surfaces 3a are wiped off by wiper 72, foreign matters may be unlikely to be pushed into the nozzles. In addition, amounts of foreign matters attaching to wiper 72 during the wiping operation may be reduced.

In yet another embodiment of the invention, at least one of the second extended portions 64 that may contact ink ejection surface 3a, upstream of the nozzles in the wiping direction, may be shorter across the longitudinal direction than the corresponding first extended portion 63. In this case also, even when first extended portions 63 contact ink ejection surface 3a, the upper edge of second extended portions 64 disposed on the upstream side in the wiping directions may not contact ink ejection surface 3a. Thus, foreign matters are unlikely to adhere to ink ejection surface 3a on the upstream side of nozzles in the wiping direction. Accordingly, when ink ejection surfaces 3a are wiped off by wiper 72, a number of foreign matters that may be pushed into the nozzles may be reduced. In addition, a number of foreign matters that may adhere to wiper 72 during the wiping operation also may be reduced.

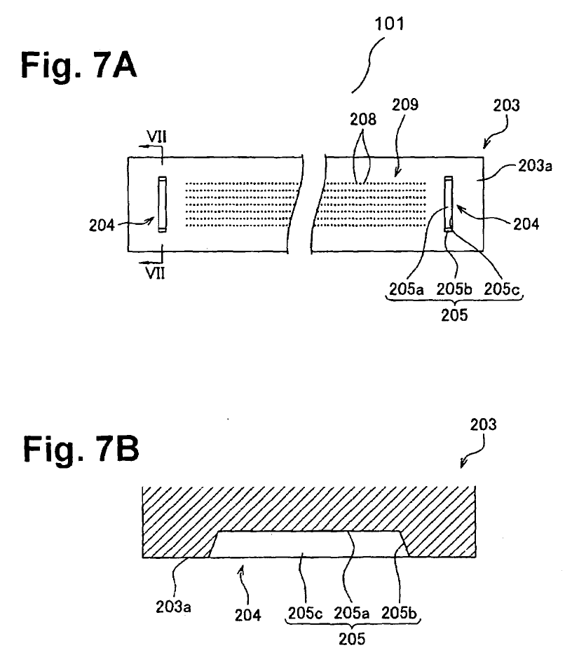

Referring to FIG. 7A-9B, an inkjet printer 101 according to still another embodiment is described herein. In the following description, like numerals are used for like corresponding parts in the various drawings. Inkjet printer 101 may be similar in some aspects to inkjet printer 1. Therefore, only the differences between inkjet printer 101 and inkjet printer 1 may be discussed with respect to inkjet printer 101.

Similar to head body 3 of the first embodiment, head body 203 may comprise an ink ejection surface 3a that may serve as the bottom surface of head body 203. Ink ejection surface 3a may have a plurality of nozzles 208, which may comprise a nozzle group 209. Recesses 204 may be provided on ink ejection surface 3a. These recesses 204 may fit over projections 265 of second extended portions 264. Recesses 204 may be positioned such that recesses 204 interpose all nozzles 208 therebetween, in the longitudinal direction of ink ejection surface 3a. More specifically, recesses 204 may be positioned on ink ejection surface 3a upstream and downstream of nozzles 208 in the wiping direction of wiper 72. Each recess 204 may extend longer than a width of nozzle group 209 in the width direction of ink ejection surface 3a.

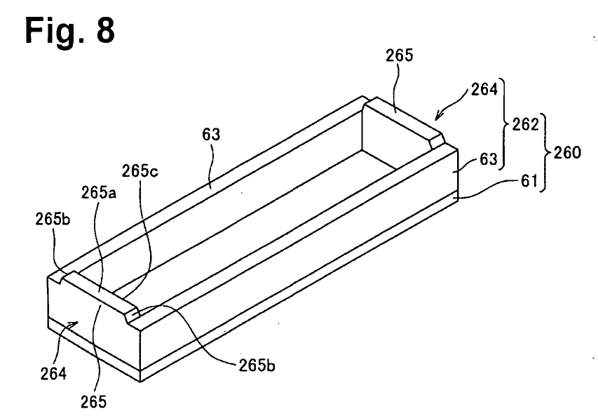

As shown in FIGS. 7A and 7B, each recess 204 may comprise a bottom surface 205a, end surfaces 205b parallel to the longitudinal direction of ink ejection surface 3a, and side surfaces 205c perpendicular to the longitudinal direction of ink ejection surface 3a. Referring to FIG. 8, recess 204 may be configured to have a depth such that upper surfaces 265a of projections 265 contact with corresponding bottom surfaces 205a when first extended portions 63 contact ink ejection surface 3a. Referring again to FIGS. 7A and 7B, end surfaces 205b may contact end surfaces 265b of projection 265 when first extended portions 63 contact ink ejection surface 3a. As shown in FIG. 7B, end surfaces 205b may slope inwardly from the opening of recess 204 of ink ejection surface 3a toward bottom surface 205a. Side surfaces 205c may extend substantially perpendicularly to ink ejection surface 3a.

As shown in FIG. 8, cap 260 may comprise a plate member 61 and an enclosure 262 extending upward from a periphery of plate member 61. Similar to enclosure 62, enclosure 262 may be formed of any suitable elastic material. Enclosure 262 may comprise a plurality of e.g., a pair of first extended portions 63 and a plurality of, e.g., a pair of second extended portions 264. Second extended portions 264 may be connected to first extended portions 63 at their respective ends. Second extended portions 264 may extend along the width direction of cap 260, e.g., parallel to the width direction of ink ejection surface 203a. Cap 260 may define a recess that opens toward ink ejection surface 203a. Each second extended portion 264 may have a projection 265 that extends from a height of corresponding first extended portion 63 to a predetermined height which may be higher than the first extended portion 63. For each second extended portion 264, corresponding projection 265 may be positioned along an entire length of each second extended portion 264. Upper surfaces 265a may be either substantially the same size as or slightly smaller than the bottom surface 205, such that projections 265 may fit into relevant recesses 204 when upper edges of first extended protrusions 63 contact ink ejection surface 203a. End surfaces 265b of projections 265 may have a slope corresponding to the slope of end surfaces 205b of recesses 204. Side surfaces 265c of projection 265 may extend perpendicular to ink ejection surface 203a.

When cap 260 covers substantially all nozzles 208 formed on ink ejection surface 203a, and when upper edges of first extended portions 63 contact ink ejection surface 203a, upper surfaces 265a of projections 265 may contact bottom surfaces 205a of recesses 204. End surfaces 265b of projections 265 may contact end surfaces 205b of recesses 204. Thus, a space enclosed by cap 260 and ink ejection surface 203a may be brought into an almost sealed state, which may reduce or prevent drying of ink in the nozzles 208. As end surfaces 265b of projections 265 and end surfaces 205b of recesses 204 slope, a contacting force between end surfaces 265b and end surfaces 205b may increase relative to a contacting force between end surfaces 265a, 205b that extend perpendicular to ink ejection surface 203a.

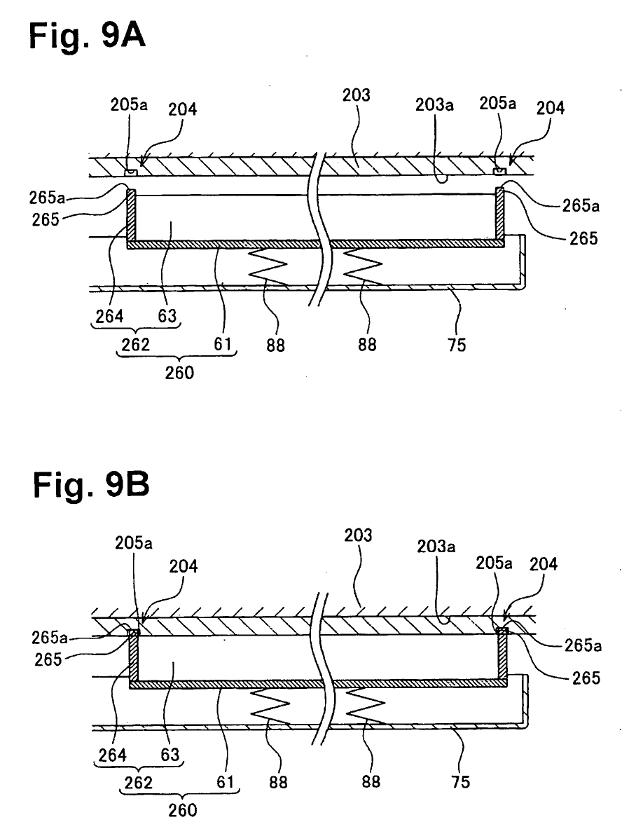

Referring to FIGS. 9A and 9B, cap 260 may be urged upward by a plurality of e.g., two, springs 88 while being supported by the bottom surface of tray 75. According to this embodiment, a capping operation to cover nozzles 208 formed on each ink ejection surface 203a with corresponding caps 260 may be discussed below. Similarly to the first embodiment, frame moving mechanisms 51 may move inkjet heads 2 from print position to the head maintenance position. With trays 71, 75 connected to each other via hook members 83, driving mechanism 91 may move both trays 71, 75 to the maintenance position by. Enclosure 262 of cap 260 may be positioned opposite to a periphery of an area of ink ejection surface 203a where nozzles 208 may be formed. More specifically, first extended portions 63 may be positioned opposite to longitudinal peripheral portions of the nozzle area of ink ejection surface 203a, and projections 265 of second extended portions 264 may be positioned opposite to recesses 204.

As shown in FIG. 9B, frame moving mechanisms 51 may cause inkjet heads 2 to be lowered, until upper edges of first extended portions 63 contact ink ejection surface 203a. At the time of contact, upper surfaces 265a of projections 265 also may contact bottom surfaces 205a of recesses 204, and end surfaces 265b of projections 265 may contact end surfaces 205b of recesses 204. Thus, a space defined by cap 260 and ink ejection surface 203a may be brought into a state which is almost sealed. This state may reduce or prevent drying of ink in the nozzles 208.

When first extended portions 63 of enclosure 262 contact ink ejection surface 203a, contact between second extended portions 264 and ink ejection surface 203a may be prevented, as projections 265 may fit into relevant recesses 204. Therefore, a number of foreign matters which may adhere to ink ejection surface 203a at a portion upstream or downstream of nozzles 208 in the wiping direction may be reduced. Accordingly, when ink ejection surface 203a is wiped off by wiper 72, a number of foreign matters pushed into nozzles 208 also may be reduced. Further, when a portion of wiper 72 wipes nozzles 208, via ink ejection surface 203, a number of foreign matters adhering to projections 265 and then transferring or adhering to a portion of wiper 72 may be reduced. As a number of foreign matters that adhere to a portion of wiper 72 where it wipes nozzles 208, may be reduced, consequently, a number of foreign matters that are pushed into the nozzles 208 when ink ejection surface 203a is again wiped by wiper 72 also may be reduced.

In this embodiment, projection 265 may be positioned higher than first extended portion 63 on an entire upper portion of second extended portion 264. Nevertheless, in another embodiment, projection 265 may be positioned higher than first extended portion 63 on a part of an upper portion of second extended portion 264, and projection 265 may not be positioned higher than first extended portion 63 on another part of second extended portion 264. Further, corresponding recess may be provided on ink ejection surface 203a. In this embodiment, as the projection which is configured to fit into the recess is formed on second extended portions 264, an end portion of second extended portion 264, where the projection is formed, may avoid contacting ink ejection surface 203a when first extended portions 63 contact ink ejection surface 203a. Therefore, a number of foreign matters adhering to ink ejection surface 203a in the upstream and downstream of nozzles 208 in the wiping direction may be reduced. Accordingly, when ink ejection surface 203a is wiped off by wiper 72, a number of foreign matters pushed into nozzles 208 may be reduced. Further, a number of foreign matters that will adhere to wiper 72 during the wiping operation may be reduced.

According to still another embodiment of the invention, a projection may be positioned on an entire upper portion of second extended portions 264 which are positioned on an upstream side of nozzles 208 in the wiping direction, and corresponding recesses configured to fit over the projections may be positioned on ink ejection surface 203a. In this embodiment, when first extended portions 63 contact ink ejection surface 203a, an upper edge of the projection of upstream-side second extended portion 264 in the wiping direction may avoid contact ink ejection surface 203a. Therefore, a number of foreign matters which may adhere to ink ejection surface 3a at a portion upstream of nozzles 208 in the wiping direction may be decreased. Thus, when ink ejection surface 203a is wiped off by wiper 72, a number of foreign matters that are pushed into nozzles 208 may be reduced. Further, a number of foreign matters that will adhere to wiper 72 during the wiping operation also may be reduced.

For example, inkjet heads 2 may be lowered in the above-described embodiments, to bring wiper 72 into contact with ink ejection surfaces 3a, 203a. Nevertheless, in still a further embodiment, wiper 72 may be raised to contact ink ejection surface 3a, 203a. Further, in the above-described embodiments, the wiper 72 which may contact ink ejection surfaces 3a, 203a may be horizontally moved. Nevertheless, in still a further embodiment, inkjet heads 2 may be horizontally moved, which may allow wiper 72 to contact ink ejection surface 3a, 203a. Further, second extended portions 64, 264 may extend in a direction to cross the extending, e.g., longitudinal direction of first extended portions 63, other than the direction perpendicular to the extending, e.g., longitudinal direction of first extended portions 63. In an embodiment mentioned above, upper surfaces 265a of projections 265 may contact bottom surfaces 205a of recesses 204 and end surfaces 265b of projections 26 may contact end surfaces 205b of recesses 204 when upper edges of first extended portions 63 contact ink ejection surface 203a. Nevertheless, upper surfaces 265a and optionally, end surfaces 265b may avoid contact with bottom surfaces 205a and optionally end surfaces 205b, respectively. Further, end surfaces 265b of projections 265 and end surfaces 205b of recesses 204 may extend in a direction perpendicular to ink ejection surface 203a.

While the invention has been described in connection with various example structures and illustrative embodiments, it will be understood by those skilled in the art that other variations and modifications of the structures and embodiments described above may be made without departing from the scope of the invention. Other structures and embodiments will be apparent to those skilled in the art from a consideration of the specification or practice of the invention disclosed herein. It is intended that the specification and the described examples are illustrative with the true scope of the invention being defined by the following claims.

What is claimed is:

1. An inkjet recording apparatus comprising:
an inkjet head comprising an ejection surface having a plurality of ink ejection openings formed therethrough;
a cap comprising a plurality of first extended portions and a plurality of second extended portions, wherein each of the plurality of first and second extended portions comprises a leading edge closest to the ejection surface, and the plurality of first and second extended portions combine to define at least one enclosure configured to open toward the ejection surface; and
a particular moving mechanism configured to move at least one of the cap and the inkjet head between a first position and a second position, wherein at least a portion of each of the first extended portions extends further toward the ejection surface than each of the plurality of second extended portions, and wherein when the inkjet head and the cap are in a first position, at least a portion of each of the plurality of first extended portions contacts the ejection surface, and at least a portion of the leading edges of each of the plurality of second extended portions is a predetermined nonzero distance from the ejection surface.

2. The inkjet recording apparatus of claim 1, further comprising a wiper configured to selectively contact the ink ejection surface.

3. The inkjet recording apparatus of claim 2, further comprising a further moving mechanism configured to move at least one of the wiper and the inkjet head between a first wiper position and a second wiper position, wherein when the wiper and the inkjet head move from the first wiper position to the second wiper position, the wiper contacts the ejection surface.

4. The inkjet recording apparatus according to claim 1, wherein the plurality of first extended portions extend closer to the ejection surface than one of the plurality of second extended portions, and wherein when the inkjet head and the cap are in the first position, the first extended portions contact the ejection surface, the leading edge of the one of the plurality of second extended portions is a predetermined nonzero distance away from the ink ejection surface.

5. The inkjet recording apparatus of claim 4, further comprising:
a wiper configured to selectively contact the ink ejection surface; and
a further moving mechanism configured to move at least one of the wiper and the inkjet head in a wiper movement direction between a first wiper position and a second wiper position, wherein when the wiper and the inkjet head move from the first wiper position to the second wiper position, the wiper contacts the ejection surface, and wherein the one of the plurality of second extended portions is located closer to the first wiper position than all other second extended portions.

6. The inkjet recording apparatus of claim 4, further comprising:
a wiper configured to selectively contact the ink ejection surface; and
a further moving mechanism configured to move at least one of the wiper and the inkjet head in a wiper movement direction between a first wiper position and a second wiper position, wherein when the wiper and the inkjet head move from the first wiper position to the second wiper position, the wiper contacts the ejection surface, and wherein the one of the plurality of second extended portions is located closer to the second wiper position than all other second extended portions.

7. The inkjet recording apparatus of claim 1, wherein the plurality of first extended portions have a constant height.

8. The inkjet recording apparatus of claim 1, wherein the plurality of first extended portions extend in parallel to each other, and wherein the plurality of second extended portions also extend in parallel to each other.

9. The inkjet recording apparatus of claim 8, wherein the first extended portions and the second extended portions are perpendicular to each other, and wherein the second extended portions are connected to ends of the first extended portions.

10. An inkjet recording apparatus comprising:
an inkjet head comprising an ejection surface having a plurality of ink ejection openings formed therethrough, and at least one projection recess formed therein;
a cap comprising a plurality of first extended portions and a plurality of second extended portions, wherein each of the plurality of first and second extended portions comprises a leading edge closest to the ejection surface, and the plurality of first and second extended portions combine to define at least one enclosure configured to open toward the ejection surface; and
a particular moving mechanism configured to move at least one of the cap and the inkjet head between a first position and a second position,
wherein the plurality of first extended portions extend a predetermined distance toward the ejection surface, and at least one of the plurality of second extended portions comprises at least one projection that extends closer to the ejection surface than the plurality of first extended portions and wherein when the cap and the inkjet head are in the first position, the first extended portions contact the ejection surface, and the at least one projection enters a corresponding at least one projection recess in the ejection surface.

11. The inkjet recording apparatus of claim 10, wherein the at least one projection recess comprises at least one inner surface configured to contact at least an edge of the at least one projection when the at least one projection enters the at least one projection recess.

12. The inkjet recording apparatus of claim 10, wherein the at least one projection comprises a plurality of edges, the at least one projection recess comprises a plurality of inner surfaces configured to contact the plurality of edges of the at least one projection, and the plurality of edges are positioned at an angle with respect to the ejection surface.

13. The inkjet recording apparatus of claim 10, further comprising a wiper configured to selectively contact the ink ejection surface.

14. The inkjet recording apparatus of claim 13, further comprising a further moving mechanism configured to move at least one of the wiper and the inkjet head between a first wiper position and a second wiper position, wherein when the wiper and the inkjet head move from the first wiper position to the second wiper position, the wiper contacts the ejection surface.

15. The inkjet recording apparatus of claim 10, further comprising:
a wiper configured to selectively contact the ink ejection surface; and
a further moving mechanism configured to move at least one of the wiper and the inkjet head in a wiper movement direction between a first wiper position and a second wiper position, wherein when the wiper and the inkjet head move from the first wiper position to the second wiper position, the wiper contacts the ejection surface, and wherein the at least one projection is positioned on the second extended portion that is positioned closer to the first wiper position than all other second extended portions.

16. The inkjet recording apparatus of claim 10, further comprising:
a wiper configured to selectively contact the ink ejection surface; and
a further moving mechanism configured to move at least one of the wiper and the inkjet head in a wiper movement direction between a first wiper position and a second wiper position, wherein when the wiper and the inkjet head move from the first wiper position to the second wiper position, the wiper contacts the ejection surface, and wherein the at least one projection is positioned on the second extended portion that is positioned closer to the second wiper position than all other second extended portions.

17. The inkjet recording apparatus of claim 10, wherein the plurality of first extended portions extend in parallel to each other, and wherein the plurality of second extended portions also extend in parallel to each other.

18. The inkjet recording apparatus of claim 17, wherein the first extended portions and the second extended portions are perpendicular to each other, and wherein the second extended portions are connected to ends of the first extended portions.
